(19) United States
(12) Patent Application Publication
(10) Pub. No.: US 2012/0323553 A1
(43) Pub. Date: Dec. 20, 2012

(54) Mobile Emulator Integration

(75) Inventors: Muhammad Bilal Aslam, Redmond, WA (US); Crystal L. Hoyer, Seattle, WA (US); Vishal R. Joshi, Redmond, WA (US); Timothy Michael McBride, Snohomish, WA (US); William E. Hiebert, Redmond, WA (US)

(73) Assignee: MICROSOFT CORPORATION, Redmond, WA (US)

(21) Appl. No.: 13/161,518

(22) Filed: Jun. 16, 2011

(51) Int. Cl. G06F 9/455

(52) U.S. Cl. 703/28; 703/23

(57) ABSTRACT

Aspects of the subject matter described herein relate to recommending data sources. In aspects, a request to provide recommendations of data enrichments for a database is received at a recommendation engine. The recommendation engine may perform static and dynamic analysis of data associated with the database and may further refine recommendations based on policies. The recommendation engine may then provide the recommendations, if any, of data enrichments to allow a software developer, for example, to indicate whether the data enrichments are to be used.

### BACKGROUND

Software developers who develop mobile web sites often like to test if these web sites render correctly on various mobile devices. To do this, they may publish their web site and try to access it from a mobile device. This can become a time-consuming and tedious process as the web site may be re-published and re-loaded on the mobile device multiple times in the course of development. In addition, debugging these web sites using the development tool may also be very limited.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to mobile emulator integration. In aspects, an indication of a desired mobile device to emulate is received by a component of a development platform. In one approach, an appropriate emulator is installed, if needed, and executed to emulate the mobile device, a browser is launched within the emulator, and the browser is instructed to load a Web page. After a development session ends, the emulator may be uninstalled. In another approach a browser emulator is provided with an identifier of the mobile device. The browser emulator finds characteristics of the mobile device and emulates a browser appropriate for the mobile device.

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that represents an exemplary environment in which aspects of the subject matter described herein may be implemented;

FIG. 3 is a block diagram that represents another exemplary environment in which aspects of the subject matter described herein may be implemented; and

FIGS. 4-5 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

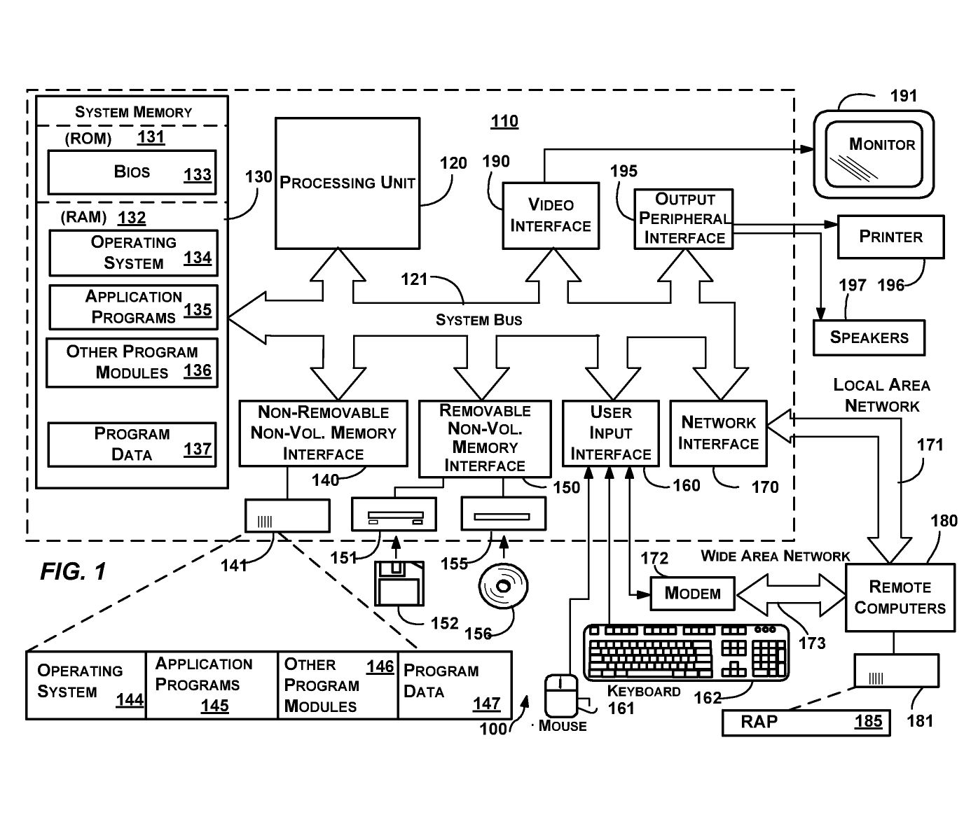

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Emulator Integration

As mentioned previously, developing Web pages for mobile devices may be time-consuming and tedious. Wherever the term “mobile device” is used herein, in one embodiment, this term means a device that is designed to be held in one or two hands while interacting with the device. Such devices include cell phones, smartphones, and other mobile phones, PDAs, hand held gaming devices, and the like. In other embodiments, this term means a computing device that is designed to generally not be held in human hands while being used. Such devices include personal computers, lap top computers, notebook computers, automobile-embedded or attached computing devices, other mobile devices, computing appliances, printers, and the like.

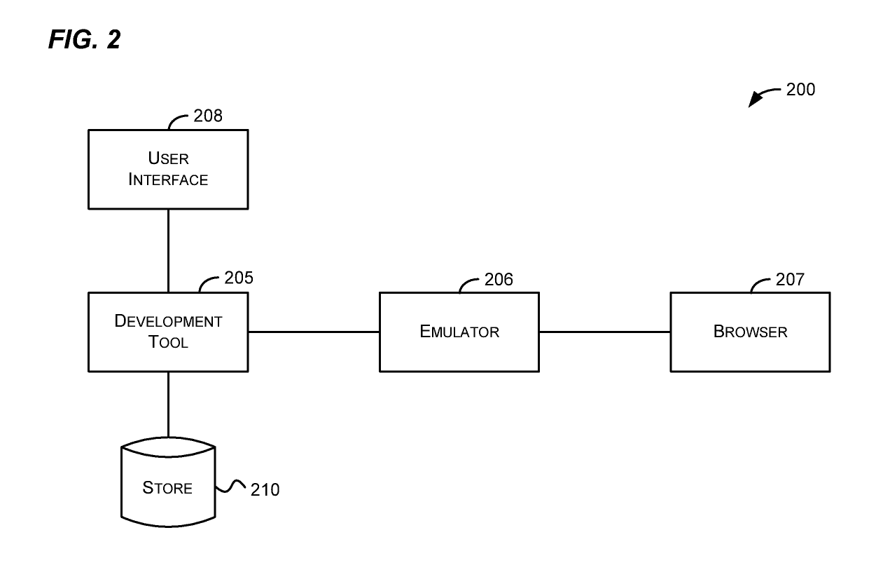

FIG. 2 is a block diagram that represents an exemplary environment in which aspects of the subject matter described herein may be implemented. The components illustrated in FIG. 2 are exemplary and are not meant to be all-inclusive of components that may be needed or included. In other embodiments, the components described in conjunction with FIG. 2 may be included in other components (shown or not shown) or placed in subcomponents without departing from the spirit or scope of aspects of the subject matter described herein.

As used herein, the term component is to be read to include hardware such as all or a portion of a device, a collection of one or more software modules or portions thereof, some combination of one or more software modules or portions thereof and one or more devices or portions thereof, and the like.

Turning to FIG. 2, the environment 200 may include a development tool 205, an emulator 206, a browser 207, a user interface 208, a store 210, and other components (not shown). A development platform may include one or more of the development tool 205, the emulator 206, other installable emulators (not shown), the browser 207, the user interface 208, and the store 210. The development platform may be hosted on one or more computers.

The various components may be located relatively close to each other (e.g., on the same machine or on machines on the same network) or may be distributed across the world. The various components may communicate with each other via various networks including intra- and inter-office networks.

The development tool 205, emulator 206, and user interface 208 may comprise or reside on one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as one of the above comprises the computer 110 of FIG. 1.

The development tool 205 may include a process that is capable of communicating with one or more of the other entities of FIG. 2. The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. Likewise, the development tool 205 may have components that are distributed over one or more devices.

In one embodiment, the development tool 205 may include a software development tool. The software development tool may implement an integrated development environment (IDE) that allows a software developer to enter and update code, debug code, create and update databases, associate the code with one or more databases, compile the code, create packages, do other actions, and the like.

In operation, the development tool 205 may interface with a user via the user interface 208. The user interface 208 may include a keyboard, pointing device, monitor, and other input and output devices mentioned in conjunction with FIG. 1. Through the user interface 208, the user may indicate a desire to develop software for a particular type of mobile device. For example, the user may enter a brand and model of a mobile device via the user interface 208.

In response, the development tool 205 may determine whether an emulator is installed that can emulate the indicated mobile device. To do this, the development tool 205 may consult the store 210. The store 210 may include an indication of installed emulator(s), installable emulators, data that indicates where code that implements the emulators may be found, data regarding mobile devices including characteristics of devices associated with emulators, and the like. The code that implements an emulator may be stored locally or remotely without departing from the spirit or scope of aspects of the subject matter described herein.

The store 210 is any storage media capable of storing data. The store may include volatile memory (e.g., a cache) and non-volatile memory (e.g., a persistent storage). The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

If after consulting the store 210, the development tool 205 determines that an indicated (e.g., by the software developer) emulator is not installed, the development tool 205 may install and execute the emulator (e.g., the emulator 206). In conjunction with executing an emulator, the development tool 205 may instruct the emulator to launch a browser and to load within the emulator a Web page indicated by the development tool 205. The Web page may be a page the software developer wants to debug or change, a new page the software developer wants to develop, or the like.

In being operable to instruct an emulator to launch a browser, the development tool 205 retrieve an identifier of the mobile device from the store and to pass the identifier to the emulator. In response, the emulator may receive the identifier, retrieve data that includes a size (e.g., dimensions) of a display of the mobile device, a browser to use for the mobile device, and a rendering engine to use for rendering within the browser.

An emulator may include software, hardware, or a combination of hardware and software. An emulator may be used to mimic hardware and/or software of a device. For example, a printer may emulate a popular printer so that the printer is compatible with software that is used with the popular printer. As another example, a computer may emulate another device (e.g., such as a mobile device) to develop, test, and/or maintain compatibility with software designed to run on the other device.

There is no intention by using the term emulator to limit emulators to devices that are specifically built to emulate other devices and have no other purpose. Indeed, a general purpose computer may have software and/or hardware that may be used to emulate another device.

The browser 207 is an application that executes on the emulator 206. The browser 207 may be used to browse Web sites including a Web site created by the development tool 205. The user interface 208 may display a control that displays the output of the emulator 206. This output may include, for example, the rendering of the browser 207. The control may also include device specific input to be provided to the emulator 206. For example, the control may include a rotate button to allow the display of the emulator to be rotated 90 degrees as is found in some mobile devices. As another example, the control may also include other buttons that correspond to buttons that are specific to a particular mobile device emulated by the emulator 206.

The development tool 205 may be operable to install and execute an emulator on demand. For example, the development tool 205 may be operable to perform actions, including:

1. Determining whether an indicated emulator is already installed in the development platform;

2. If the emulator is not already installed, installing the emulator on the development platform; and

3. After installing or determining that the indicate emulator is already installed, executing the emulator.

The development tool 205 may also be used to assist in debugging a Web page rendered in the browser 207. For example, the development tool 205 may cause a process to attach to the emulator 206 and may then communicate with that process to perform debugging actions such as running code to a particular point, setting and removing breakpoints, stepping through code, and the like. As will be appreciated by those skilled in the art, this integration may greatly speed software development for Web sites that are to be viewed in the browser 207.

The development tool 205 may also be operable to uninstall an emulator in response to ending a development session for a mobile device associated with the emulator.

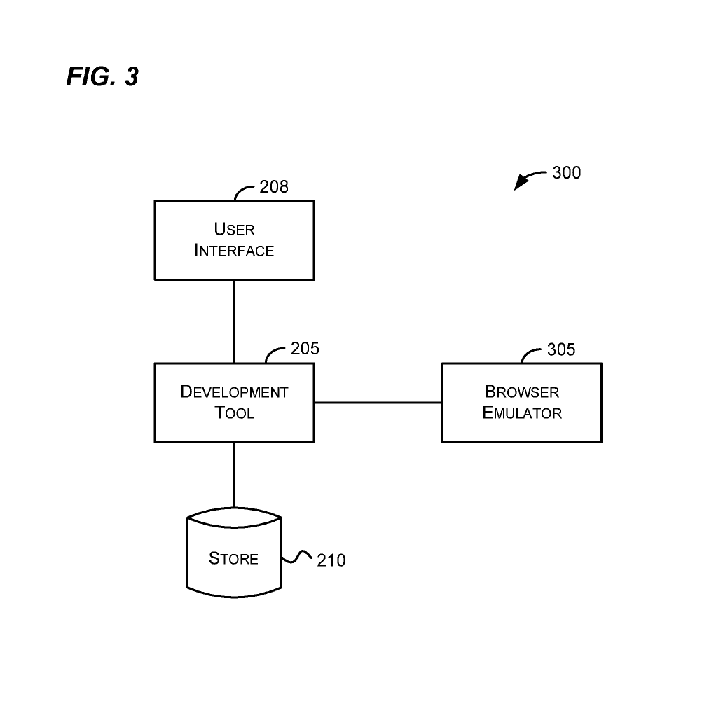

FIG. 3 is a block diagram that represents another exemplary environment in which aspects of the subject matter described herein may be implemented. In FIG. 3, the development tool 205, the user interface 208, and the store 210 of FIG. 2 have been repeated and may act similarly to how they have been described in conjunction with FIG. 2 with some exceptions mentioned below.

In particular, the environment 300 of FIG. 3 includes a browser emulator 305 and does not include a device emulator. The browser emulator 305 is a component that is capable of emulating the browsers found on one or more mobile devices.

It will be readily understood that mobile devices often have different screen sizes and ways of interacting with a browser. Furthermore, the mobile devices may have different rendering engines and/or skins applied. For example, a mobile device produced by Apple may be configured to use SAFARI® while a mobile device produced by Microsoft may be configured to use INTERNET EXPLORER®. These browsers look different (e.g., have different skins) and may use different rendering engines.

Instead of using a device emulator, the development tool 205 may use the browser emulator 305 and supply an identifier of a device. The browser emulator 305 may use the identifier to obtain characteristics (e.g., screen dimensions, color characteristics, rotation capability, and the like) of the device as well as characteristics (e.g., browser name, skin, rendering engine, and the like) of a browser commonly or exclusively used on the device. Using this, the browser emulator 305 may emulate the browser of the device including the browser's rendering engine without emulating the actual device itself. In some implementations, the browser emulator 305 may emulate a browser of a device but may emulate a different rendering engine than is normally used by the browser.

The development tool 205 may also be used for debugging purposes with respect to a browser emulated by the browser emulator 305. For example, the development tool 205 may cause a process to attach to the browser emulator 305 and may then communicate with that process to perform debugging actions such as running code to a particular point, setting and removing breakpoints, stepping through code, and the like. As will be appreciated by those skilled in the art, this integration may greatly speed software development for Web sites that are to be viewed in the browser emulated by the browser emulator 305.

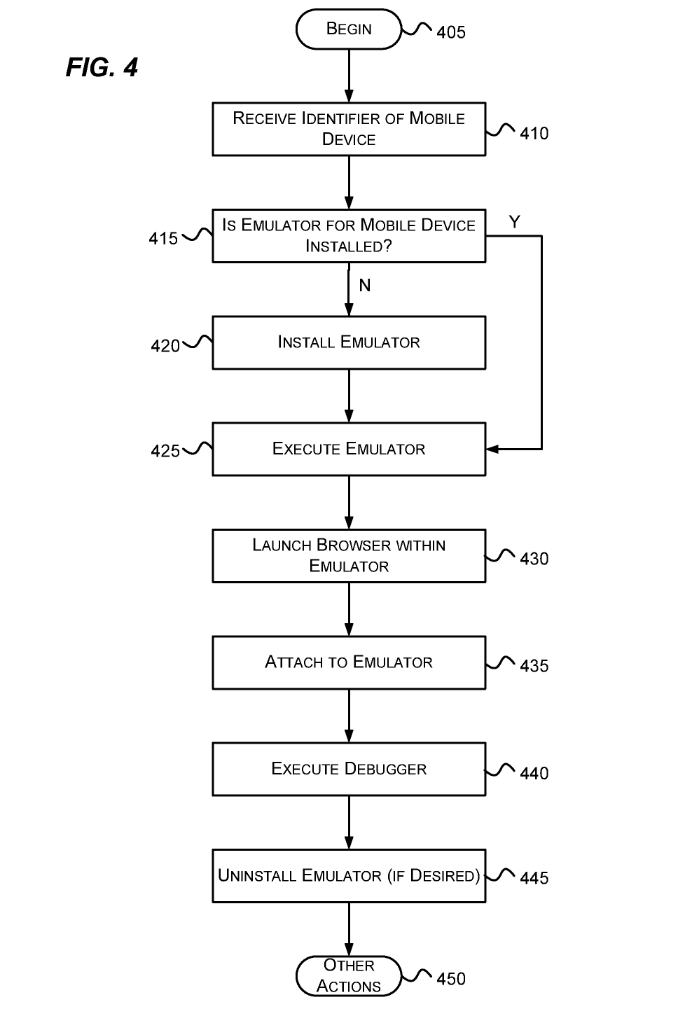

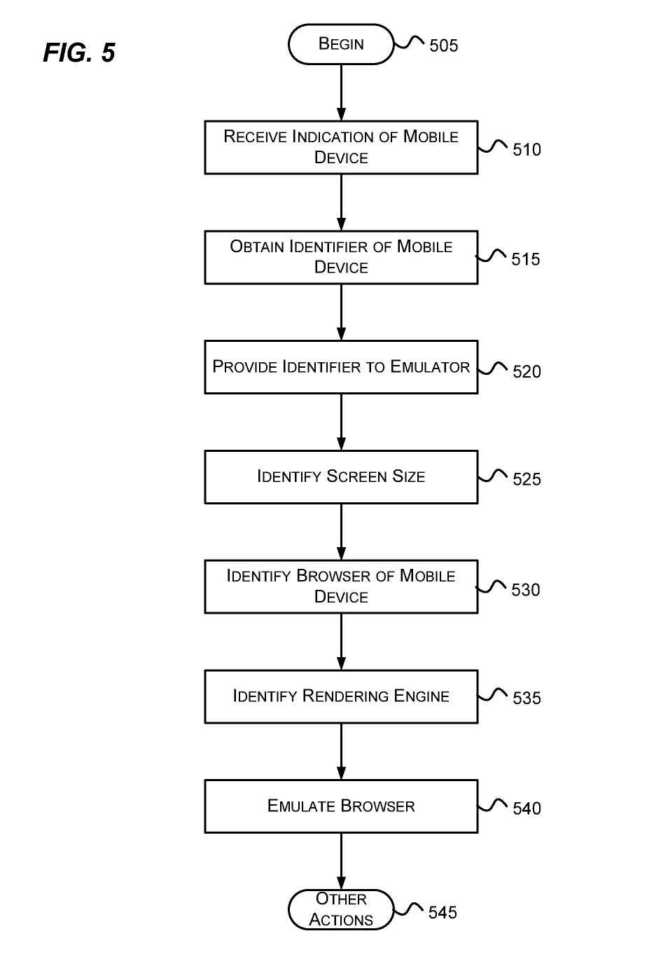

FIGS. 4-5 are flow diagrams that generally represent exemplary actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410, an identifier of a mobile device is received at a component of a development platform. For example, referring to FIG. 2, the development tool 205 may receive an identifier of a mobile device from the user interface 208. For example, the user interface 208 may present one or more drop down lists, menus, or other controls that allow a software developer to indicate a mobile device that is to be emulated. The identifier (e.g., a string, set of values, other data, or the like) received from the user interface 208 may in turn be used to obtain an emulator identifier from a data structure (e.g., on the store 210), a service, a database, or some other process that receives the data provided by the user interface and provides an emulator identifier and possible other data such as the location of code of the emulator.

At block 415, a determination is made as to whether an emulator for the mobile device is already installed on the development platform. If an emulator for the mobile device is not installed, the actions continue at block 420; otherwise, the actions continue at block 425. For example, referring to FIG. 2, the development tool 205 may consult (e.g., access data) the store 210. This data indicates what emulators, if any, are already installed on the development platform.

At block 420, the emulator is installed on the development platform. For example, referring to FIG. 2, the development tool 205 may find a location of the code for the emulator using data on the store 210. The development tool 205 may find that the data is available locally (e.g., on a local hard drive or other local storage media) or via a remote repository (e.g., via store accessible over a network). If the code for the emulator is available remotely, the development tool 205 may retrieve the code from the remote repository and install the emulator on the development platform.

At block 425, the emulator is executed. This may involve spawning a process to execute code that implements the emulator. For example, referring to FIG. 2, the development tool 205 may execute code that implements the emulator 206.

At block 430, the emulator is instructed to launch a browser and to load within the browser a Web page developed via the development platform. For example, referring to FIG. 2, the development tool 205 may instruct the emulator 206 to execute a browser and to load a Web page indicated by an HTTP address provided by the development tool 205 to the emulator 206. In response, the emulator 206 may launch the browser and refer the browser to the HTTP address. In one implementation, the development tool 205 may provide the HTTP address while instantiating and executing the emulator 206. In another implementation, the emulator 206 may use an application programming interface (API) of the emulator 206 to instruct the emulator to load and execute the Web page indicated by the HTTP address.

At block 435, a process may attach to the emulator for use in debugging the Web page. The process is operable to communicate with the development platform to set and remove breakpoints, to allow code of the Web page to execute to a breakpoint, and to pause the emulator at the breakpoint until instructed to resume execution by the development platform.

At block 440, the debugger is executed on the development platform. For example, the development tool 205 may spawn a process to load a debugger that may then communicate debug messages with the process attached to the emulator 206. Debug messages may include breakpoints, instructions to run or pause, variable and other values, other debug data, and the like. This may allow a software developer, for example, to set breakpoints and debug a Web page for a mobile device using an IDE of the development tool 205.

At block 445, the emulator is uninstalled if desired. For example, referring to FIG. 2, the development tool 205 may be configured to uninstall an emulator after a development session ends. For example, when the software developer indicates that the project associated with a Web page is to be closed, this may indicate the end of a development session. As another example, a software developer may identify (e.g., via the user interface 208) another mobile device to test and this may implicitly indicate the end of a development session. In conjunction with the session ending, the development tool 205 may uninstall the emulator 206 if the development tool 205 is configured to do so.

At block 450, other actions, if any, may be performed.

Turning to FIG. 5, at block 505, the actions begin. At block 510, an indication of a mobile device is received. For example, referring to FIG. 3, the development tool 205 may receive an indication (e.g., a string, set of values, other data, or the like) of a mobile device from the user interface 208. For example, the user interface 208 may present one or more drop down lists, menus, or other controls that allow a software developer to indicate a mobile device that is to be emulated.

At block 515, an identifier of the mobile device is obtained. For example, referring to FIG. 3, the development tool 205 may use the indication received above to obtain an emulator identifier from a data structure (e.g., on the store 210), a service, a database, or some other process.

At block 520, the identifier is provided to a browser emulator. For example, referring to FIG. 3, the development tool 205 may provide the emulator identifier obtained above to the browser emulator 305.

At block 525, the screen size of the mobile device may be obtained. For example, referring to FIG. 3, the browser emulator 305 may obtain the screen size (e.g., dimensions) of a mobile device using the emulator identifier it received. The browser emulator 305 may access a database, service, or other repository to obtain the screen size.

At block 530, a browser associated with the mobile device is identified. For example, referring to FIG. 3, the browser emulator 305 may use the emulator identifier to lookup the most commonly or exclusively used browser for a mobile device.

At block 535, the render engine associated with the browser is identified. For example, referring to FIG. 3, the browser emulator 305 may use the browser identified above to lookup (e.g., in a data structure) the rendering engine associated with the browser.

At block 540, the browser is emulated using the rendering engine and the screen size to load a Web page indicated by the development platform. For example, referring to FIG. 3, the browser emulator 305 may emulate a browser of a mobile device and load a Web page indicated by the development tool 205.

At block 545, other actions, if any, may be performed. For example, referring to FIG. 5, the development tool may attach a process to the browser emulator and communicate with the attached process via a debugger. As another example, the user interface 208 may display a control operable to receive input to indicate rotation of the mobile device. In response to receiving this input, the browser emulator 305 may rotate its Web page within a control (e.g., Window) associated with the browser emulator.

As can be seen from the foregoing detailed description, aspects have been described related to mobile emulator integration. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving, at a component of a development platform, an identifier of a mobile device;
determining whether an emulator for emulating the mobile device is already installed on the development platform;
if the emulator is not already installed, installing the emulator on the development platform;
executing the emulator;
instructing the emulator to launch a browser and to load within the browser a Web page developed via the development platform.

2. The method of claim 1, further comprising determining if code for the emulator is available locally, and if not, retrieving the code from a remote repository.

3. The method of claim 1, further comprising attaching a process to the emulator for use in debugging the Web page, the process operable to communicate with the development platform to set and remove breakpoints, to allow code of the Web page to execute to a breakpoint, and to pause the emulator at the breakpoint until instructed otherwise by the development platform.

4. The method of claim 3, further comprising executing a debugger on the development platform and communicating a debug message with the process via the debugger.

5. The method of claim 1, further comprising uninstalling the emulator in response to ending a development session for the mobile device.

6. The method of claim 1, wherein receiving, at a component of a development platform, an identifier of a mobile device comprises receiving the identifier via a user interface.

7. The method of claim 1, wherein determining whether an emulator for emulating the mobile device is already installed on the development platform comprises consulting a store to access data that indicates whether the mobile device is already installed on the development platform.

8. The method of claim 1, further comprising determining an identifier of the emulator via one or more of a data structure, service, and a database.

9. In a computing environment, a development platform, comprising:
a store that includes data regarding mobile devices;
a user interface operable to receive an indication of a mobile device; and
a development tool operable to use the indication of the mobile device together with the data regarding mobile devices to perform actions, comprising instructing an emulator to launch a browser and to load within the browser a Web page indicated by the development platform.

10. The development platform of claim 9, wherein the development tool is further operable to perform additional actions, comprising:
determining whether the emulator is already installed in the development platform;
if the emulator is not already installed, installing the emulator on the development platform; and
executing the emulator.

11. The development platform of claim 9, wherein the development tool being operable to instruct the emulator to launch a browser comprises the development tool being operable to retrieve an identifier of the mobile device from the store and to pass the identifier to the emulator, the emulator being operable to receive the identifier, retrieve data that includes a size of a display of the mobile device, a browser to use for the mobile device, and a rendering engine to use for rendering within the browser.

12. The development platform of the claim 9, wherein the development tool further comprises a debugger operable to communicate with a process attached to the emulator to provide assistance in debugging the Web page.

13. The development platform of claim 12, wherein the debugger being operable to communicate with the process comprises the debugger being operable to communicate data regarding breakpoints, messages that indicate that the process is to pause the emulator until instructed otherwise, and messages that indicate that the process is to resume execution of the emulator.

14. The development platform of claim 9, wherein the development tool is further operable to uninstall the emulator in response to ending a development session for the mobile device.

15. The development platform of claim 9, wherein the development tool is further operable to determine an identifier of the emulator via one or more of a data structure, service, and a database.

16. The development platform of claim 9, wherein the emulator is operable to emulate the mobile device.

17. The development platform of claim 9, wherein the emulator is operable to emulate a browser associated with the mobile device.

18. A computer storage medium having computer-executable instructions, which when executed perform actions, comprising:
receiving an indication of a mobile device;
using the indication to identify an identifier of the mobile device;
providing the identifier to a browser emulator;
identifying a screen size of the mobile device;
identifying a browser associated with the mobile device;
identifying a rendering engine associated with the browser;
emulating the browser via the browser emulator by using the rendering engine and the screen size to load a Web page indicated by the development platform.

19. The computer storage medium of claim 18, further comprising attaching a process to the browser emulator and communicating via the process to a debugger of the development platform.

20. The computer storage medium of claim 18, further comprising displaying a control operable to receive input to indicate rotation of the mobile device, receiving input indicating the rotation, and in response displaying the Web page rotated within a control associated with the browser emulator.
